(19) United States
(12) Patent Application Publication
(10) Pub. No.: US 2016/0295091 A1
(43) Pub. Date: Oct. 6, 2016

(54) METHOD AND APPARATUS FOR CAPTURING IMAGES

(71) Applicant: NOKIA TECHNOLOGIES OY, Espoo (FI)

(72) Inventor: Ilia Safonov, Moscow (RU)

(21) Appl. No.: 15/035,279

(22) PCT Filed: Nov. 3, 2014
(86) PCT No.: PCT/FI2014/050820

§ 371 Date: May 9, 2016

(30) Foreign Application Priority Data
Nov. 11, 2013 (RU) 2013150049

(51) Int. Cl. H04N 5/232; H04N 5/247

(52) U.S. Cl. CPC H04N 5/23203; H04N 5/247

(57) ABSTRACT

In accordance with an example embodiment of the present invention, a method is disclosed. The method comprises: storing motion information comprising at least one motion feature in a memory; determining a triggering moment related to at least one motion feature; receiving motion sensor signals by a master device; detecting the triggering moment in the received motion sensor signals; and issuing, by the master device, a command to capture one or more images when the triggering moment has been detected.

### TECHNICAL FIELD

The present application relates generally to image capturing technology. More specifically, the present invention relates to a method and an apparatus for capturing images.

### BACKGROUND

Many portable devices have some means of capturing photos and videos today. A vast majority of mobile phones, tablet devices and the like comprise a digital camera. Further, the quality of mobile phone cameras is constantly improving. However, it is still common to use a professional or semi-professional Digital Still Camera (DSC) which allows capturing a series of frames with high shutter speed, to shoot, for example, a scene with fast motion. After that the best frame is usually selected manually.

A number of remote controls are also used to make pictures on digital devices, for example a remote for a digital camera or a smartphone. In some solutions, one digital camera can be set as a master camera, and other digital cameras are set as secondary cameras that shoot simultaneously with the master camera.

High speed cameras enable taking pictures on high speed but they are not always available when needed. Further, although remote controls provide assistance in taking pictures it remains a challenge to be able to take a picture at a desired moment.

### SUMMARY

Various aspects of examples of the invention are set out in the claims.

According to a first aspect of the present invention, a method is disclosed. The method comprises: storing motion information comprising at least one motion feature in a memory; determining a triggering moment related to at least one motion feature; receiving motion sensor signals by a master device; detecting the triggering moment in the received motion sensor signals; and issuing, by the master device, a command to capture one or more images when the triggering moment has been detected.

The method may be, for example, a method for capturing images by one or more devices.

According to an embodiment, detecting the triggering moment comprises determining at least one motion sensor signal feature from the received motion sensor signals; and comparing the determined at least one motion sensor signal feature with the at least one motion feature stored in the memory.

According to an embodiment, the method further comprises: establishing a wireless connection between a master device and one or more secondary devices; and issuing a command to at least one of the secondary devices to start providing motion sensor signals. According to the embodiment, motion sensor signals are received by the master device from at least one of the secondary devices.

According to an embodiment, receiving motion sensor signals comprises receiving motion sensor signals by the master device from at least one of the secondary devices.

According to an embodiment, issuing a command to capture one or more images comprises issuing the command to capture one or more images to the master device.

According to an embodiment, issuing a command to capture one or more images comprises issuing the command to capture one or more images to at least one of the secondary devices.

According to an embodiment, the method further comprises downloading or receiving the stored motion information by the master device.

According to an embodiment, the method further comprises initiating a trial session and, during the trial session: receiving motion sensor signal samples by the master device; recording the received motion sensor signal samples; and determining at least one motion feature from the recorded motion sensor signal samples, and storing the at least one motion feature in the memory.

According to an embodiment, the method further comprises the following steps during the trial session: establishing a wireless connection between a master device and one or more secondary devices; and issuing a command to at least one of the secondary devices to start providing motion sensor signals, wherein receiving motion sensor signal samples during the trial session comprises receiving motion sensor signal samples by the master device from at least one of the secondary devices.

According to an embodiment, the method further comprises: recording video by the master device, and synchronizing the recorded video with the received motion sensor signal sample.

According to an embodiment, the method further comprises: receiving a selection of a desired moment on the recorded video from a user; and selecting a motion feature corresponding to the desired moment on the recorded video, wherein determining a triggering moment related to at least one motion feature comprises determining a triggering moment related to the selected motion feature.

According to an embodiment, the method further comprises: adjusting at least one image capture property based on the received motion sensor signals prior to issuing the command to capture one or more images, wherein issuing the command to capture one or more images further comprises issuing a command to capture one or more images using the adjusted at least one image capture property.

According to an embodiment, the method further comprises adjusting at least image capture property based on the stored motion information prior to issuing the command to capture one or more images, wherein issuing the command to capture one or more images further comprises issuing a command to capture one or more images using the adjusted at least one image capture property.

According to an embodiment, adjusting at least image capture property includes adjusting at least one of the following properties: exposure, shutter speed and aperture.

According to an embodiment, the method further comprises sharing captured images between the master device and one or more secondary devices.

According to a second aspect of the present invention, an apparatus is disclosed. The apparatus comprises at least one processor; and at least one memory including computer program code. The at least one memory and the computer program code are configured to, with the at least one processor, cause the apparatus to perform at least the following: store motion information comprising at least one motion feature in the memory; determine a triggering moment related to at least one motion feature; receive motion sensor signals by the apparatus; detect the triggering moment in the received motion sensor signals; and issue a command to capture one or more images when the triggering moment has been detected.

According to an embodiment the at least one memory and the computer program code are configured to, with the at least one processor, cause the apparatus to further perform the following: detect the triggering moment by determining at least one motion sensor signal feature from the received motion sensor signals, and comparing the determined at least one motion sensor signal feature with the at least one motion feature stored in the memory.

According to an embodiment the at least one memory and the computer program code are configured to, with the at least one processor, cause the apparatus to further perform the following: establish a wireless connection between the apparatus and one or more secondary devices; issue a command to at least one of the secondary devices to start providing motion sensor signals; and receive motion sensor signals by the apparatus device from at least one of the secondary devices.

According to an embodiment the at least one memory and the computer program code are configured to, with the at least one processor, cause the apparatus to further perform the following: issue a command to capture one or more images to the apparatus.

According to an embodiment the at least one memory and the computer program code are configured to, with the at least one processor, cause the apparatus to further perform the following: issue a command to capture one or more images to at least one of the secondary devices.

According to an embodiment the at least one memory and the computer program code are configured to, with the at least one processor, cause the apparatus to further perform the following: download or receive the stored motion information.

According to an embodiment the at least one memory and the computer program code are configured to, with the at least one processor, cause the apparatus to further initiate a trial session and, during the trial session: receive motion sensor signal samples by the apparatus; record the received motion sensor signal samples; and determine at least one motion feature from the recorded motion sensor signal samples, and store the at least one motion feature in the memory.

According to an embodiment the at least one memory and the computer program code are configured to, with the at least one processor, cause the apparatus to further perform the following during the trial session: establish a wireless connection between the apparatus and one or more secondary devices; issue a command to at least one of the secondary devices to start providing motion sensor signals; and receive motion sensor signals by the apparatus from at least one of the secondary devices.

According to an embodiment the at least one memory and the computer program code are configured to, with the at least one processor, cause the apparatus to further perform the following: record video by the apparatus; and synchronize the recorded video with the received motion sensor signals.

According to an embodiment the at least one memory and the computer program code are configured to, with the at least one processor, cause the apparatus to further perform the following: receive a selection of a triggering moment on the recorded video from a user; select a motion feature corresponding to the desired moment on the recorded video; wherein the triggering moment is determined related to the selected motion feature.

According to an embodiment the at least one memory and the computer program code are configured to, with the at least one processor, cause the apparatus to further perform the following: adjust at least one image capture property based on the received motion sensor signals prior to issuing the command to capture one or more images.

According to an embodiment the at least one memory and the computer program code are configured to, with the at least one processor, cause the apparatus to further perform the following: adjust at least one image capture property based on the stored motion information prior to issuing the command to capture one or more images.

According to an embodiment the at least one memory and the computer program code are configured to, with the at least one processor, cause the apparatus to further adjust at least one of the following properties: exposure, shutter speed and aperture.

According to an embodiment the at least one memory and the computer program code are configured to, with the at least one processor, cause the apparatus to further perform the following: share captured images between the apparatus and one or more secondary devices.

According to a third aspect of the present invention, a computer program is disclosed. The computer program comprises: code for storing motion information comprising at least one motion feature in a memory; code for determining a triggering moment related to at least one motion feature; code for receiving motion sensor signals; code for detecting the triggering moment in the received motion sensor signals; and code for issuing a command to capture one or more images when the triggering moment has been detected; when the computer program is run on a processor.

According to an embodiment, the computer program is a computer program product comprising a computer-readable medium bearing computer program code embodied therein for use with a computer.

According to a fourth aspect of the present invention, an apparatus is disclosed. The apparatus comprises a processor configured to: store motion information comprising at least one motion feature in the memory; determine a triggering moment related to at least one motion feature; receive motion sensor signals by the apparatus; detect the triggering moment in the received motion sensor signals; and issue a command to capture one or more images when the triggering moment has been detected.

According to a fifth aspect of the present invention, a computer-readable medium is disclosed. The computer-readable medium comprises a computer program having program code instructions that, when executed by a computer, perform the following: storing motion information comprising at least one motion feature in a memory; determining a triggering moment related to at least one motion feature; receiving motion sensor signals; detecting the triggering moment in the received motion sensor signals; and issuing a command to capture one or more images when the triggering moment has been detected.

According to a sixth aspect of the present invention, an apparatus is disclosed. The apparatus comprises means for storing motion information comprising at least one motion feature in the memory; means for determining a triggering moment related to at least one motion feature; means for receiving motion sensor signals by the apparatus; means for detecting the triggering moment in the received motion sensor signals; and means for issuing a command to capture one or more images when the triggering moment has been detected.

### BRIEF DESCRIPTION OF THE DRAWINGS

For a more complete understanding of exemplary embodiments of the present invention, reference is made to the following descriptions in combination with the accompanying drawings in which:

FIG. 1 is a flow diagram showing operations for a method according to one embodiment;

FIG. 2 is a flow diagram showing operations for a method according to one embodiment;

FIG. 3 is a flow diagram showing operations for an example of a trial session according to one embodiment;

FIG. 4 is a flow diagram showing operations for an example of the main photographing session according to one embodiment;

FIG. 5 is a diagram of accelerometer magnitude vs. time for a jump.

FIG. 6 is a block diagram of an apparatus according to one embodiment.

### DETAILED DESCRIPTION OF THE DRAWINGS

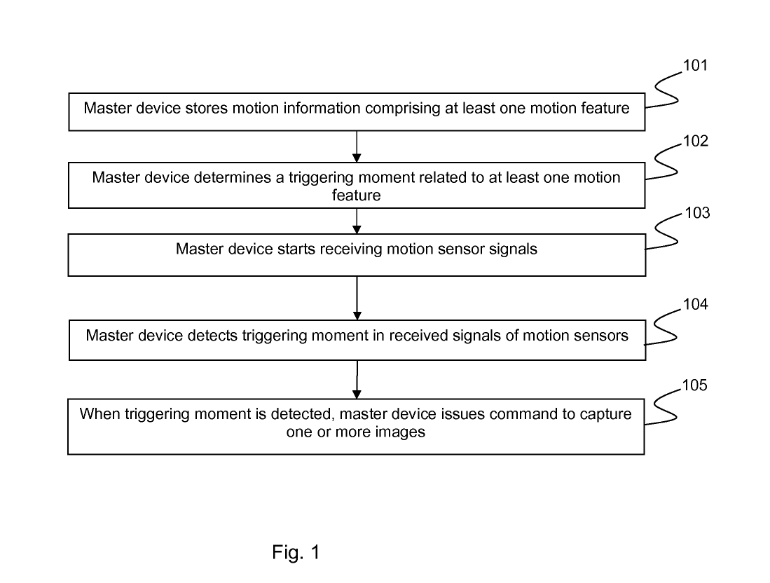

An exemplary embodiment of the present invention and its potential advantages are understood by referring to FIGS. 1 through 5 of the drawings.

FIG. 1 shows operations of a method according to one embodiment of the present invention. Motion information comprising at least one motion feature is stored on a master device (step 101). The master device may be an apparatus such as, for example, a portable phone, a digital camera, a remote control or a tablet device. The motion information comprises at least one motion feature. Such feature may relate to, but is not limited to, a certain desirable part of the motion that a user wishes to capture. For example, the motion feature may relate to change in acceleration at a highest point during a jump, or to a certain shape of a motion sensor signal sample which relates to a particular motion. The motion feature may also be a single acceleration sample value. This feature may directly accessible in the stored motion information or encoded.

The master device determines a triggering moment related to at least one motion feature (102). In one embodiment, the triggering moment is the moment on which a command to capture an image should be sent so that the image would be taken at a desired point of time. The triggering moment may take into account the delay produced by an apparatus taking the image. The triggering moment may be substantially the moment in time when the photograph needs to be taken, or it may be before the moment when the photo needs to be taken.

The master device then starts receiving motion sensor signals (103). A motion sensor may include, for example, an accelerometer and/or a gyroscope (more precisely angular velocity sensor) which reflect the motion profile. Microelectromechanical systems (MEMS) barometer (pressure sensor) may reflect motion too and be a part of the motion sensor, as well as the sensor fusion.

After the master device starts receiving motion sensor signals, it detects the triggering moment in the received signals (104). The triggering moment in the received signals is the moment which triggers issuing the command to capture images.

When the triggering moment has been detected, the master device issues a command to capture one or more images (105). The master device may issue this command to itself, in other words, command to use its own camera. It may also issue the command to capture one or more images to at least one secondary device. The master device may issue the command immediately upon detection of the triggering moment, or after a delay.

These operations may be carried out by various means, for example by a processor in an apparatus, or by encoding them into a computer program and running on a processor. The processor may be part of an apparatus such as, for example, a computer, a mobile phone, a tablet, a digital camera or any other suitable device. The proposed method may be implemented, for example, as one or more cooperating applications for smartphones or other mobile devices. The functionality may also be implemented, for example, in the operational system of mobile devices.

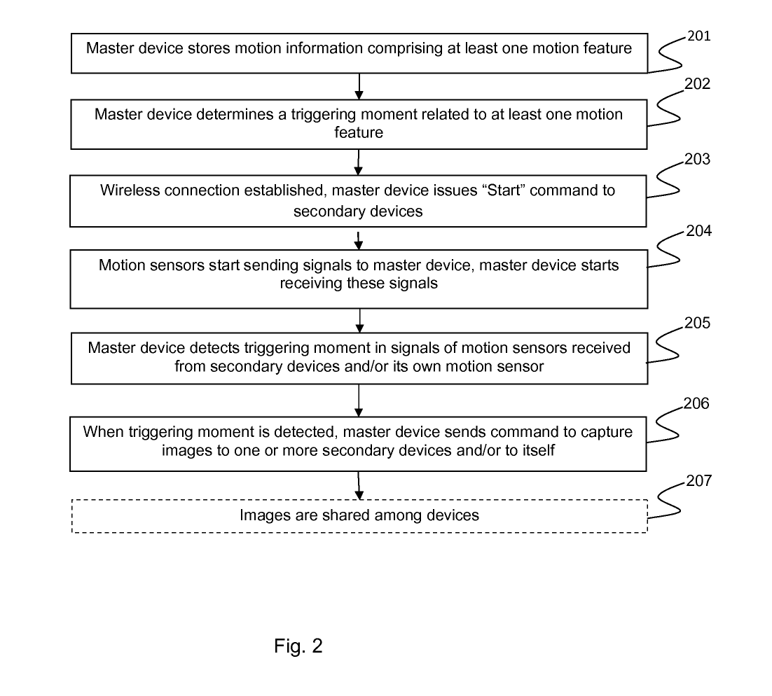

FIG. 2 shows operations of a method according to one embodiment of the present invention. In this method, at least two devices are used, with one master device and one or more secondary devices.

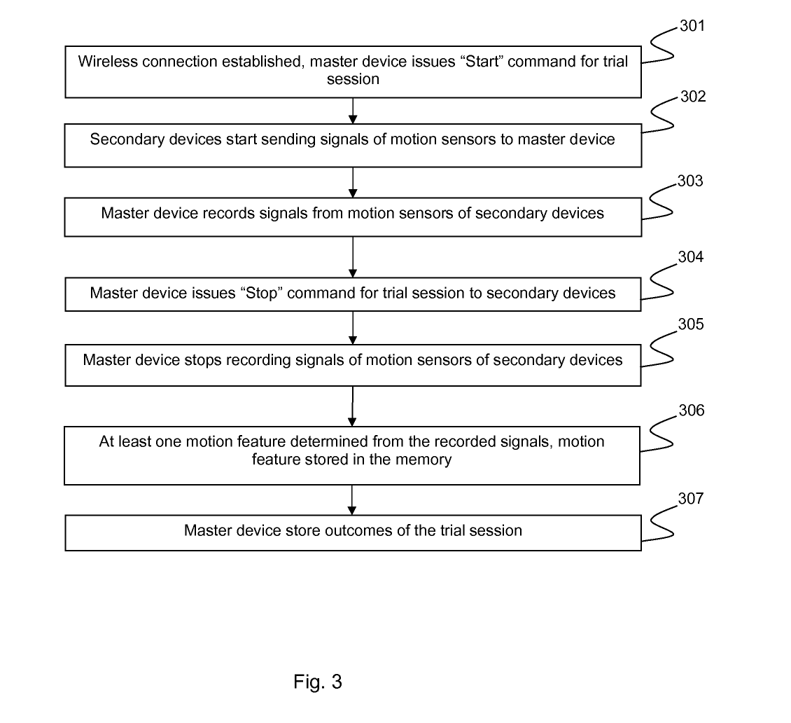

Motion information comprising at least one motion feature is stored on the master device (step 201). The master device may be an apparatus such as, for example, a cell phone, a digital camera, a remote control or a tablet. The motion information stored on the master device may have been downloaded from a server in the Internet or received earlier from another device, copied to the master device or generated by it. The information may have been generated in advance by performing a trial session earlier. The optional trial session is described in more detail with reference to FIG. 3.

The motion information comprises at least one motion feature. Such feature may relate to, but is not limited to, a certain desirable part of the motion that the user wishes to capture. For example, the motion feature may relate to change in acceleration at a highest point during a jump, or to a certain shape of a motion sensor signal sample which relates to a particular motion, or to a certain acceleration value. This feature may be directly accessible in the stored motion information or encoded. An example of motion information is a pre-recorded motion sensor signal profile which has certain features. A user may store profiles concrete motion in a collection (library) and apply them in a shooting situation.

The master device determines a triggering moment related to at least one motion feature (202). This may be done, for example, by receiving a selection from a user or automatically. The triggering moment related to a feature is determined to trigger the shooting later, and therefore, it may be determined so that the interesting motion is captured on the resulting image. For example, it may be determined substantially at the moment when a desired change in acceleration in the highest position of a jump is reached, or slightly before this moment to compensate for camera delay. Alternatively, it may be selected, for example, based on the motion sensor signal samples manually or automatically.

Wireless connection between the master device and at least one secondary device is established, and the master device issues a “Start” command to secondary devices (step 203). The wireless connection may be, but is not limited to, a Wifi or Bluetooth connection. The wireless connection may be established as the first operation, or alternatively, as one of the subsequent steps before receiving motion sensor signals from secondary devices (i.e. before step 204 on FIG. 2). The master device may be equipped with a wireless connection module such as a Wifi or Bluetooth module. The secondary devices may also be equipped with a similar wireless module.

Motion sensors then start sending signals to the master device, and the master device starts receiving these signals (204). Signals may be received substantially in real-time, i.e. with negligible delay, or in a series of discrete samples. Sampling frequency of the signals may be, for example, from 200 to 400 Hz. A motion sensor may include, for example, an accelerometer and/or a gyroscope (more precisely angular velocity sensor) which reflect the motion profile. Microelectromechanical systems (MEMS) barometer (pressure sensor) may reflect motion too and be a part of the motion sensor, as well as the sensor fusion. According to one embodiment, there may be one or more motion sensors sending signals to the master device. One of the motion sensors may be the motion sensor of the master device itself, while other motion sensors may be installed in one or more secondary devices. The secondary devices may be separated into groups of measuring secondary devices which send motion sensor signals, and photographing secondary devices which may or may not send the motion sensor signals but receive commands to capture an image later.

After the master device has started receiving motion sensor signals, it can detect one or more triggering moments in the received signals (205). The triggering moment in the received signals is the moment which triggers the command to capture an image or images. Detection of the triggering moment may comprise determining at least one motion sensor signal feature from the received motion sensor signals and comparing one or more features of the received motion sensor signals with the at least one motion feature of the stored motion information. Determining at least one motion sensor signal feature may relate directly to a motion feature, or it may relate to determining a calculated feature of a signal representing a motion feature. For example, when the features of the received motion sensor signals match the features of the stored motion information to which the determined triggering moment relates, the triggering moment of the received signal is detected. In another embodiment, the master device may compare the received motion sensor signal samples with the stored signal samples or profiles (stored as motion information) and detect the triggering moment when it substantially matches the determined triggering moment on the stored samples or profiles.

When the triggering moment has been detected, the master device issues a command to capture one or more images (206). The master device may issue this command to itself, i.e. command to use its own camera. It may also issue, alternatively or additionally, the command to capture one or more images to at least one of the secondary devices. The at least one secondary device may be an additional photographing secondary device. The command may include instructions to capture images simultaneously for all devices, or in a predefined or random sequence. The images may be, for example, high-resolution photos.

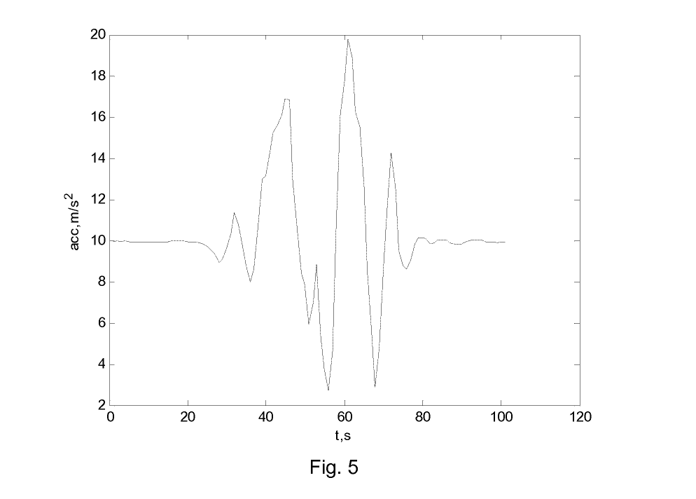

In one embodiment, at least one image capture property may be adjusted based on the received motion sensor signals, or based on the stored motion information, prior to issuing the command to capture one or more images. The at least one image capture property may include exposure, shutter speed, aperture or a combination thereof These properties may also be adjusted based on the external lighting or use of a flash. This aspect of the invention is exemplified in more detail below with reference to FIG. 5.

In an optional step 207, images may be shared among the master and secondary devices. The sharing can be done wirelessly, through the Internet or through a wired connection.

FIG. 3 shows an example of the steps of a trial session (in other words, training mode) according to an embodiment. In one embodiment, a master device and one or more secondary device are used. In another embodiment, a trial session may be performed using only the master device. A wireless connection between the master and all secondary devices (slave devices) is established. WiFi or Bluetooth or any another wireless data transmission technique can be used. If people or moving objects participate in the trial session, they can have one or more devices, i.e. secondary devices, somewhere on their body. When the participants are ready, the master device issues a “Start” command (step 301). It comprises a command to at least one of the secondary devices to start providing motion sensor signals. If manual control is required, the user may prompt to send the “Start” command by pressing a button. The secondary devices may start gathering signals of motion sensors, such as a 3-axes accelerometer, gyroscope and sensor fusion, and start sending the signals to the master device (step 302). In one embodiment, the secondary devices may generate sound signals and/or vibrating signals to the participants to indicate that they are to start making the intended motion. The master device receives and records the motion sensor signal samples of secondary devices (step 303). In one embodiment, the master device may also record video from its own camera. In case video is recorded, the two recordings (i.e. video and motion sensor signals) are synchronized. In one embodiment, samples of accelerometer and gyroscope magnitudes as well as samples of projection on vertical axis may be added to packets which are sent to the master device recording the video. The samples may also be processed by a low-pass filter for noise suppression. Frequency of the packages sending may be equal or faster than frame rate of the video.

In one embodiment, the master device may receive and record motion sensor signal samples from its own motion sensor or sensors. Similar video synchronization may be performed by the master device in this embodiment.

After the intended motions have been performed, the master device issues a “Stop” command to the secondary devices (step 304) and stops recording signals of motion sensors of the secondary devices (step 305). If video has been recorded by the master device, it also stops recording video at step 305. At least one motion feature is then determined from the recorded motion sensor signals, and at least one motion feature is stored in a memory (step 306). In one embodiment, the motion feature may be selected automatically. In another embodiment, the motion feature may be selected by receiving a selection from a user. For example, the user may select a recorded motion sensor signal sample which indicates an interesting movement. Alternatively, if video was recorded, a desired moment may be selected on the video by the user, corresponding, for example, to a moment where an interesting motion feature is detected. A motion feature in the stored motion information is then selected corresponding to the selected desired moment. Further, in one embodiment, for example, exposure time may also be optionally estimated based on motion speed.

The master device stores outcome of the trial session as part of the stored motion information (step 307). The outcomes may include synchronized video and signals of motion sensors as well as selected triggering moments. The outcome may also comprise, for example, exposure time. Further, outcomes of trial sessions may also be shared among devices and/or users.

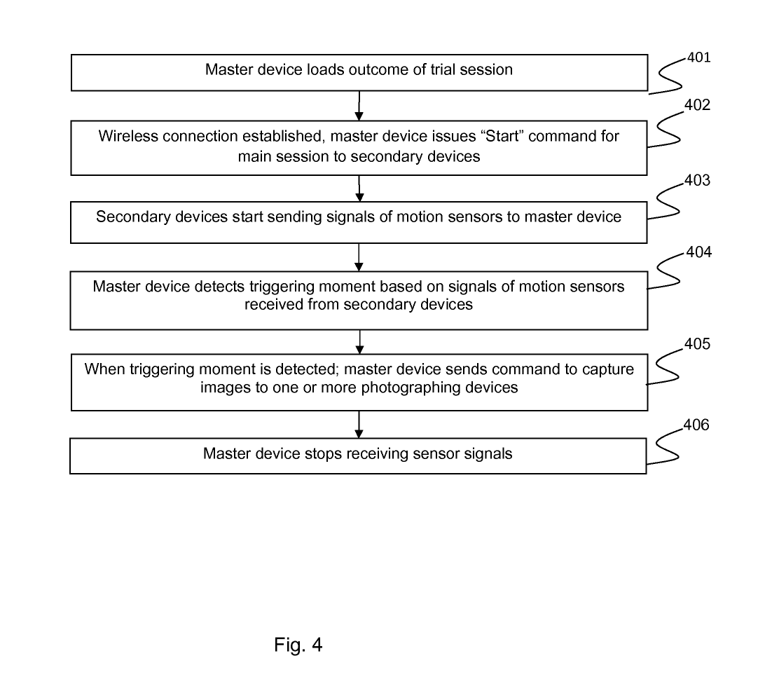

FIG. 4 shows the steps of a main session (i.e. an actual photographing session) after a trial session shown, for example in FIG. 3 or after downloading trial session data according to one embodiment of the invention. The master device loads outcome of a trial session (step 401). Outcome for given type of a dynamic motion may be selected automatically or via user input. A wireless connection between master and secondary devices is established and the master device issues a “Start” command for a main session to the secondary devices (step 402). It is evident to a skilled person that the wireless connection may also be established as a first step, as an alternative.

The secondary devices start sending motion sensor signals to the master device, and the master device starts receiving these signals (step 403). The secondary devices may send signals of motion sensors in packets with the same filtering as in trial attempts. The secondary devices may also generate a sound and/or vibrate to indicate the start of the main session. The intended motions are then performed by the participant or participants. The master device detects a triggering moment in the received motion sensor signal or signals (step 404). This can be done by determining at least one motion sensor signal feature from the received motion sensor signals and comparing the determined at least one motion sensor signal feature with the at least one motion feature stored in the memory. Determining at least one motion sensor signal feature may include determining an actual feature of a motion (for example, a sample value of measured acceleration) or a calculated representation of a motion feature. In case of such determination by comparison, a triggering moment is detected when the determined signal features substantially match with a feature or features of the stored motion information.

When the triggering moment is detected, the master device then sends a command to capture images to one or more photographing devices (step 405). The master device may be one of the photographing devices or even the only photographing device. If the triggering moment is detected for only a part of secondary devices, the master device may be configured to issue a command based on, for example, two or more detected triggering moments. Thus, several photos may be captured. In one embodiment, if several triggering moments are detected, a multi-exposure photo may be constructed from the captured photos. This may be done, for example, by taking pictures of various phases of a movement (each defined by a triggering moment) and further combining these photos into a single image. The multi-exposure photo may refer to, for example, a picture with blended semi-transparent layers, parts of multiple photos merged into one or a collage.

When a photo or photos have been captured, the master device stops receiving sensor signals (step 406). It may also issue a “Stop” command to all secondary devices to end the main session. In one embodiment, photos that have just been taken may be shared between the master and the secondary devices.

FIG. 5 shows an example of a diagram of the accelerometer magnitude for a jump with a secondary device in the pocket. On FIG. 5 a fragment which corresponds to the triggering moment is shown. The horizontal axis shows time in seconds and the vertical axis shows accelerometer magnitude in m/s². When determining or detecting the target moment, camera delay may be taken into account. An example of features of the fragment is the following: number of mean-level crossing before the fragment, sign of derivative and value of the signal and/or its derivative.

In one embodiment, for estimation of exposure time depending on motion speed, the following approach may be applied. If the master device is stationary during the trial session, then initial velocity V0 is considered zero; otherwise V0 equals to some predefined value, for example, 15 m/s. For a small time period dt, for example between two sequential samples, motion can be considered uniform and current velocity can be estimated as follows: V(i)=V(i−1)+a(i)*dt, where i=1 . . . N, a(i) is the current value of acceleration magnitude, V(0)=V0. This allows estimation of maximum velocity Vm during trial attempt. Assuming that the minimal dimension (height and/or width) of a captured image in pixels is W, and the minimal dimension of captured scene equals 2 meters, because human motion is considered and the figure corresponds to human height, an exposure time t=(2/W)/Vm allows to capture an image without motion blur. Final estimation of the exposure time could also take into account lighting conditions during main photographing attempt.

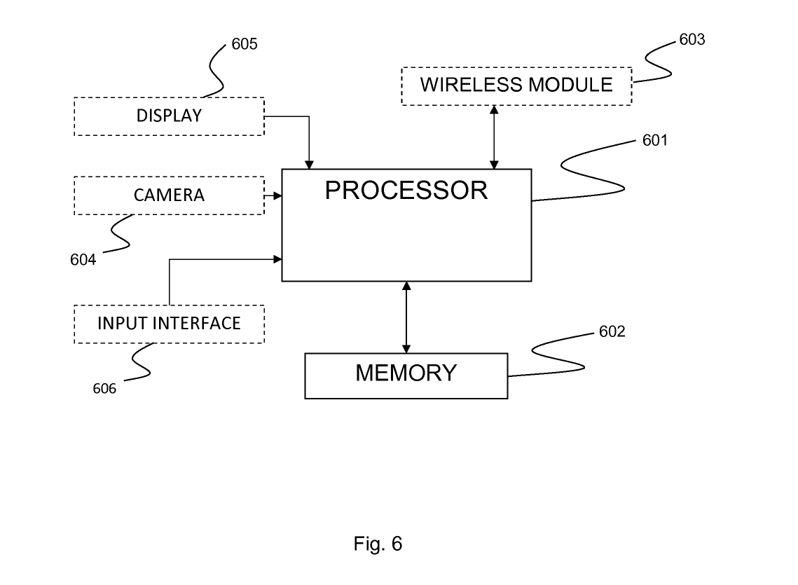

FIG. 6 illustrates a block diagram of an apparatus such as, for example, a mobile terminal, in accordance with an example embodiment of the invention. While several features of the apparatus are illustrated and will be hereinafter described for purposes of example, also other types of electronic devices, such as mobile telephones, mobile computers, Personal Digital Assistants (PDA), pagers, laptop computers, gaming devices, televisions, and other types of electronic systems or electronic devices, may employ various embodiments of the invention.

As shown, the apparatus may include at least one processor 601 in communication with a memory or memories 602. The processor 601 is configured to store, control, add and/or read information from the memory 602. It may also be configured to control the functioning of the apparatus. The apparatus may optionally comprise a wireless module 603, a camera 604, for example a digital camera, a display 605 and an input interface 606 which may all be operationally coupled to the processor 601. The processor 601 may be configured to control other elements of the apparatus by effecting control signaling. The processor 601 may, for example, be embodied as various means including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit (ASIC), or field programmable gate array (FPGA), or some combination thereof Accordingly, although illustrated in FIG. 6 as a single processor, in some embodiments the processor 601 comprises a plurality of processors or processing cores. Signals sent and received by the processor 601 in conjunction with the wireless module 603 may include signaling information in accordance with an air interface standard of an applicable cellular system, and/or any number of different wireline or wireless networking techniques, comprising but not limited to Wi-Fi, Worldwide Interoperability for Microwave Access (WiMAX), Wireless Local Area Network (WLAN), techniques such as Institute of Electrical and Electronics Engineers, IEEE, 802.11, 802.16, and/or the like. In addition, these signals may include speech data, user generated data, user requested data, and/or the like. In this regard, the apparatus may be capable of operating with one or more air interface standards, communication protocols, modulation types, access types, and/or the like. More particularly, the apparatus may be capable of operating in accordance with various first generation, 1G, second generation, 2G, 2.5G, third-generation, 3G, communication protocols, fourth-generation, 4G, communication protocols,

Internet Protocol Multimedia Subsystem (IMS), communication protocols, for example, Session Initiation Protocol (SIP), and/or the like.

The processor 601 may comprise user interface circuitry configured to control at least some functions of one or more elements of the user interface, such as, for example, the camera 604, the display 605, the input interface 606 and/or the like. The processor 601 and/or user interface circuitry of the processor 601 may be configured to control one or more functions of one or more elements of the user interface through computer program instructions, for example, software and/or firmware, stored on the memory 602 accessible to the processor 601. The memory 602 can include, for example, volatile memory, non-volatile memory, and/or the like. For example, volatile memory may include Random Access Memory (RAM), including dynamic and/or static RAM, on-chip or off-chip cache memory, and/or the like. Non-volatile memory, which may be embedded and/or removable, may include, for example, read-only memory, flash memory, magnetic storage devices, for example, hard disks, floppy disk drives, magnetic tape, etc., optical disc drives and/or media, non-volatile random access memory (NVRAM), and/or the like.

The input interface 606 may comprise devices (not shown) allowing the apparatus to receive data, such as a keypad, a touch display, a joystick, and/or at least one other input device. The apparatus may also comprise other short-range transceivers, such as, for example, an infrared (IR) transceiver, a Bluetooth™ transceiver operating using Bluetooth™ brand wireless technology developed by the Bluetooth™ Special Interest Group, a wireless universal serial bus (USB) transceiver and/or the like. The Bluetooth™ transceiver may be capable of operating according to low power or ultra-low power Bluetooth™ technology, for example, Wibree™ radio standards.

The apparatus shown on FIG. 6 may be configured to implement one or more of the embodiments shown in relation to any of FIGS. 1-4, acting as the master device.

Without in any way limiting the scope, interpretation, or application of the claims appearing below, a technical effect of one or more of the example embodiments disclosed herein is the ability to capture images of interesting moments with one or more conventional photographing devices, such as cameraphones. Another technical effect of one or more of the example embodiments disclosed herein is the precise selection of interesting moments when capturing photos of dynamic motions. Another technical effect of one or more of the example embodiments disclosed herein is automatic adjustment of image properties for dynamic motions.

Another technical effect of one or more of the example embodiments disclosed herein is avoidance of a delay between pressing button and actual capturing of an image, as well as of camera shaking due to button pressing.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-31. (canceled)

32. A method, comprising:
storing motion information comprising at least one motion feature in a memory;
determining a triggering moment related to at least one motion feature;
receiving motion sensor signals by a master device;
detecting the triggering moment in the received motion sensor signals; and
issuing, by the master device, a command to capture one or more images when the triggering moment has been detected.

33. The method of claim 32, wherein detecting the triggering moment comprises:
determining at least one motion sensor signal feature from the received motion sensor signals; and
comparing the determined at least one motion sensor signal feature with the at least one motion feature stored in the memory.

34. The method of claim 32, further comprising:
establishing a wireless connection between the master device and one or more secondary devices; and
issuing, by the master device, a command to at least one of the secondary devices to start providing motion sensor signals;
wherein receiving motion sensor signals comprises receiving motion sensor signals by the master device from at least one of the secondary devices.

35. The method of claim 32, wherein issuing a command to capture one or more images comprises issuing the command to capture one or more images to the master device.

36. The method of claim 34, wherein issuing command to capture one or more images comprises issuing the command to capture one or more images to at least one of the secondary devices.

37. The method of claim 32, further comprising:
downloading or receiving the stored motion information by the master device.

38. The method of claim 32, further comprising initiating a trial session and, during the trial session:
receiving motion sensor signal samples by the master device;
recording the received motion sensor signal samples; and
determining at least one motion feature from the recorded motion sensor signal samples, and storing the at least one motion feature in the memory.

39. The method of claim 38, further comprising, during the trial session:
establishing a wireless connection between the master device and one or more secondary devices; and
issuing a command to at least one of the secondary devices to start providing motion sensor signals;
and wherein receiving motion sensor signal samples during the trial session comprises receiving motion sensor signal samples by the master device from at least one of the secondary devices.

40. The method of claim 38, further comprising:
recording video by the master device, and
synchronizing the recorded video with the received motion sensor signal samples.

41. The method of claim 40, further comprising:
receiving a selection of a desired moment on the recorded video from a user; and
selecting a motion feature corresponding to the desired moment on the recorded video;
wherein determining a triggering moment related to at least one motion feature comprises determining a triggering moment related to the selected motion feature.

42. The method of claim 32, further comprising:
adjusting at least image capture property based on the received motion sensor signals prior to issuing, by the master device, the command to capture one or more images,
wherein issuing the command to capture one or more images further comprises issuing a command to capture one or more images using the adjusted at least one image capture property.

43. The method of claim 32, further comprising:
adjusting at least one image capture property based on the stored motion information prior to issuing, by the master device, the command to capture one or more images,
wherein issuing the command to capture one or more images further comprises issuing a command to capture one or more images using the adjusted at least one image capture property.

44. The method of claim 42, wherein adjusting at least one image capture property comprises adjusting at least one of the following properties: exposure, shutter speed and aperture.

45. The method of claim 32, further comprising:
sharing captured images between the master device and one or more secondary devices.

46. An apparatus, comprising:
at least one processor; and
at least one memory including computer program code
the at least one memory and the computer program code configured to, with the at least one processor, cause the apparatus to perform at least the following:
store motion information comprising at least one motion feature in the memory;
determine a triggering moment related to at least one motion feature;
receive motion sensor signals by the apparatus;
detect the triggering moment in the received motion sensor signals; and
issue a command to capture one or more images when the triggering moment has been detected.

47. The apparatus of claim 46, wherein the at least one memory and the computer program code are configured to, with the at least one processor, cause the apparatus to further perform the following:
detect the triggering moment by determining at least one motion sensor signal feature from the received motion sensor signals, and comparing the determined at least one motion sensor signal feature with the at least one motion feature stored in the memory.

48. The apparatus of claim 46, wherein the at least one memory and the computer program code are configured to, with the at least one processor, cause the apparatus to further perform the following:
establish a wireless connection between the apparatus and one or more secondary devices;
issue a command to at least one of the secondary devices to start providing motion sensor signals; and
receive motion sensor signals by the apparatus device from at least one of the secondary devices.

49. The apparatus of claim 46, wherein the at least one memory and the computer program code are configured to, with the at least one processor, cause the apparatus to further initiate a trial session and, during the trial session:
receive motion sensor signal samples by the apparatus;
record the received motion sensor signal samples; and
determine at least one motion feature from the recorded motion sensor signal samples, and store the at least one motion feature in the memory.

50. The apparatus of claim 49, wherein the at least one memory and the computer program code are configured to, with the at least one processor, cause the apparatus to further perform the following during the trial session:
establish a wireless connection between the apparatus and one or more secondary devices;
issue a command to at least one of the secondary devices to start providing motion sensor signals; and
receive motion sensor signals by the apparatus from at least one of the secondary devices.

51. The apparatus of claim 46, wherein the at least one memory and the computer program code are configured to, with the at least one processor, cause the apparatus to further perform the following:
adjust at least one image capture property based on the received motion sensor signals prior to issuing the command to capture one or more images.
